(19) United States
(12) Patent Application Publication
(10) Pub. No.: US 2015/0073774 A1
(43) Pub. Date: Mar. 12, 2015

(54) Automatic Domain Sentiment Expansion

(71) Applicant: Avaya Inc., Basking Ridge, NJ (US)

(72) Inventors: Lee Becker, Boulder, CO (US); Valentine C. Matula, Granville, OH (US); David Skiba, Golden, CO (US); George Erhart, Loveland, CO (US)

(73) Assignee: Avaya Inc., Basing Ridge, NJ (US)

(21) Appl. No.: 14/023,967

(22) Filed: Sep. 11, 2013

(51) Int. Cl. G06F 17/27

(52) U.S. Cl. CPC G06F 17/2785; G06F 17/2735
USPC 704/9

(57) ABSTRACT

Methods and systems for automatically extending a sentiment dictionary are provided. Starting with an initial set of elements (e.g., words, emoticons, etc.) having a known sentiment, messages can be analyzed for words frequently appearing in association with such words. As a result the frequently appearing words may then be associated with a sentiment and used to help determine the sentiment of a message.

### FIELD OF THE DISCLOSURE

The present disclosure is generally directed toward determining a sentiment. More particularly, towards automatically building on a base language with an established sentiment, to develop an expanded vocabulary and associated sentiment.

### BACKGROUND

Sentiment dictionaries comprise entries with an associated sentiment. For example, the entry “terrible” may be associated with a negative sentiment. A review of a message including the word “terrible” may then be determined to have a negative sentiment.

Humans review words and determine the sentiment, a costly and error prone processes that often has to be repeated due to changing sentiments of words, for example, “bad” and “sick” may have a positive or negative sentiment depending on when used.

### SUMMARY

It is with respect to the above issues and other problems that the embodiments presented herein were contemplated.

The embodiments herein provide for the automatic and dynamic updating of a sentiment of a message element by an enterprise. In one embodiment, the process is performed by:

1) Building a dictionary of “gold standard” words (i.e., words that have a specific meaning and sentiment already known to an enterprise). The dictionary may provide meanings of common words (e.g., words in the English language), meanings of common phrases or word combinations, meanings of enterprise-specific words, and/or meanings of word combinations.

2) Take the sentiment data (i.e., data from the dictionary) and run it against unlabeled data. The process begins with a generic base dictionary and a learning system that can change over time, using responses in a particular domain to update the model. In this step, a new domain-specific sentiment model is built by bootstrapping the generic model. More complex patterns can be learned and used to build a more complicated sentiment model by looking at co-occurring words, responses in a stream (positive or negative), looking at domain traffic to continuously build domain-specific sentiment model), and using weak generic models as a proxy for polarity (positive, negative, neutral).

3) Once the more complicated sentiment model is built, either the complicated model or the generic model can be used to train new complex models or re-train existing models.

4) The learning can add, change, or remove words from the sentiment dictionary, or sentiment for a particular entry, based on the domain monitoring.

One benefit of performing the steps above is to determine positive, negative, and neutral sentiment to assign to words, phrases, and other elements (e.g., emoticons). The sentiment information may then be useable within a contact center, for example. As a specific example, once a useable sentiment model is built for an enterprise, that enterprise can use the sentiment model to determine sentiment scores for contacts as they enter the contact center. This sentiment information can be provided to the agent before they begin processing the contact. The sentiment score can also be used for routing and/or reporting. If the sentiment analysis used for reporting, then the sentiment can be mapped to the focus (e.g., the cause of the sentiment). This mapping and reporting can help to improve contact center performance over time.

Another benefit of the sentiment score can involve determining the sentiment of a social media posting. If the sentiment is determined to be negative (or below a threshold sentiment score), then an agent in the contact center can be assigned the task of responding to the posting. By using sentiment analysis, the ability to discriminate between which social media postings should receive a response (i.e., utilize contact center resources) can be performed prior to assigning the agent to the posting (or before they enter the contact center in a social media response scenario).

The term “element” refers to an identifiable portion of a message. Most commonly, an element will be a single word. In another embodiment, an element may comprise a plurality of words wherein the combination has an identifiable sentiment different from the individual words thereof For example, the words “not,” “too,” and “bad,” when used individually, may have one sentiment (e.g., “not”=neutral, “too”=neutral, and “bad”=negative). However, the combination of words form the element, “not too bad” which may be associated with a positive sentiment. In addition to words or phrases, messages may have other aspects that may form elements.

Metadata may also form an element. For example, metadata indicating a posting site for a message may form an element. For example, “XYZ Airlines again!” may have a neutral sentiment, when examining the text portion of the message, but be associated with metadata indicating that the message was posted on, “TerribleAirlines.com,” and therefore associated with a negative sentiment.

Elements may also include emoticons, icons, slang, idioms, abbreviations, and similar portions of a message.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 is a system diagram in accordance with embodiments of the present disclosure;

FIG. 2 is a sentiment dictionary with an initial set of entries in accordance with embodiments of the present disclosure;

FIG. 3 is a diagram of two messages operable to extend the sentiment dictionary in accordance with embodiments of the present disclosure;

FIG. 4 is a table illustrating one scoring algorithm for elements in messages operable to extend the sentiment dictionary in accordance with embodiments of the present disclosure;

FIG. 5 is a message operable to have a sentiment determined by an extended sentiment dictionary;

FIG. 6 is one scoring algorithm operable to determine the sentiment of a message evaluated with an extended sentiment dictionary in accordance with embodiments of the present disclosure; and

FIG. 7 is a flowchart illustrating one method of in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The embodiments herein are described with respect to the English language as a matter of convenience. Certain non-English words may be generally known to those fluent only in the English language (e.g., “My trip to Mexico was ‘bueno!’”) and, for the purposes herein, be considered English words. It should be noted that the embodiments herein contemplate other languages.

Furthermore, enterprises may work in one or more particular domains of business (e.g., travel, insurance, entertainment, financial services, and so on). The use of one particular domain is for illustration purposes only and is not intended to limit the embodiments to that domain or any particular domain.

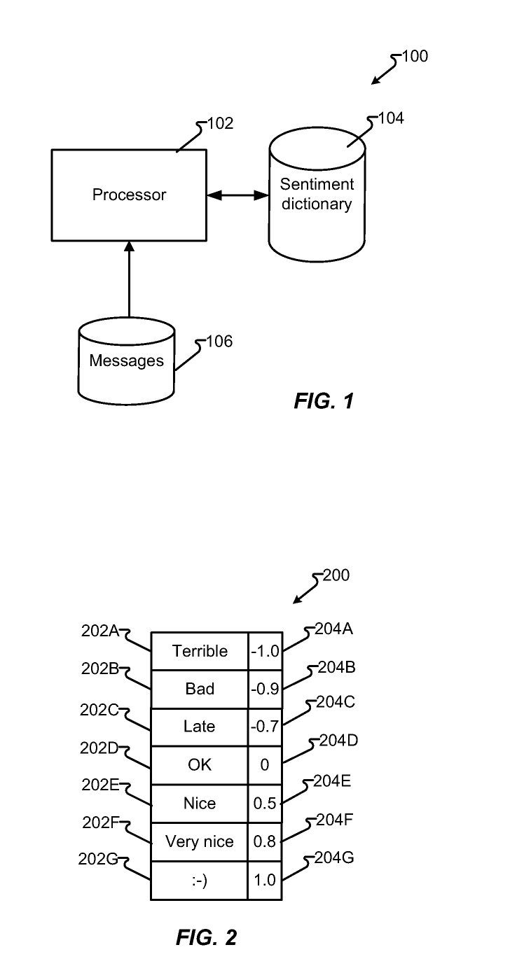

FIG. 1 illustrates system diagram 100 in accordance with embodiments of the present disclosure. Processor 102 connects to sentiment dictionary 104 and messages 106. Processor 102 may utilize a bus, network connection, or another communication means, alone or in combination, to transfer data to and from sentiment dictionary 104 and/or messages 106.

In one embodiment sentiment dictionary 104 is a database and is operable to add, delete, and update records therein. Records may include entries for elements and their associated sentiment. One embodiment of messages 106 is a database operable to store messages and/or collect messages from social media sites (e.g., Facebook, Twitter, YouTube, etc.), text of websites (e.g., blogs), RSS feeds, emails, and/or speech-to-text applications. Furthermore, while the embodiments herein are generally directed towards written messages, the use of speech recognition technology may also be employed to implement certain embodiments herein in a speech-based platform.

Sentiment dictionary 104 and message 106 are illustrated as distinct data storage devices. In other embodiments, at least one of sentiment dictionary 104 and messages 106 are in a plurality of data storage devices. In yet another embodiment, sentiment dictionary 104 and messages 106 are within the same data storage device.

FIG. 2 is sentiment dictionary 200 with an initial set of entries 202 in accordance with embodiments of the present disclosure. In one embodiment, sentiment dictionary 200 is pre-populated, such as with the “gold standard” words 200 and associated sentiment 204. Sentiment dictionary 200 may have been populated with entries 202 and sentiments 204 by one or more humans skilled in language analysis in general and/or for a particular domain.

In the embodiment illustrated, elements 202A-202F are single words, element 202F is a combination of words, and element 202G is an emoticon. As described above, elements 202 may include more complex phrases, meta-data, or other message attributes. The sentiment 204A-202G associated with elements 202A-202G, respectively, is assigned by a human, expert system, fuzzy logic, or other means whereby a base sentiment dictionary, (e.g., sentiment dictionary 200) may be established.

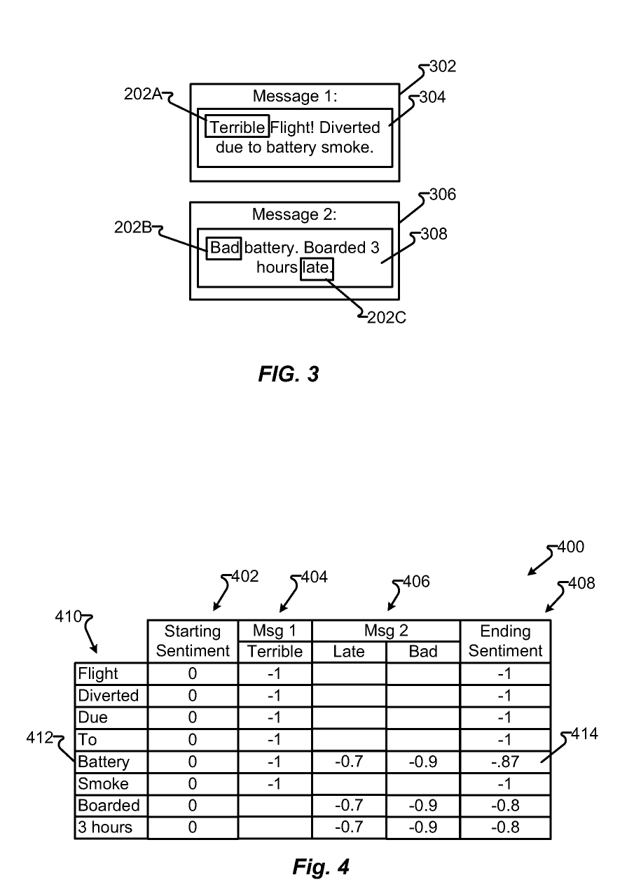

FIG. 3 is diagram of two messages 302, 306 operable to extend the sentiment dictionary 200 in accordance with embodiments of the present disclosure. In one embodiment, messages 302, 306 are messages whereby elements to add to sentiment dictionary 200 are identified.

Message 1 (302) has text 304 which includes element 202A, identified in sentiment dictionary 200. Similarly, message 2 (306) has text 308 and includes elements 202B and 202C. Elements to add to sentiment dictionary 200 may then be determined by portions of text 304 and 308, such as descried with respect to FIG. 4.

FIG. 4 is table 400 illustrating one scoring algorithm for elements in messages operable to extend the sentiment dictionary in accordance with embodiments of the present disclosure. In one embodiment, column 410 includes words from message 1 (302) and message 2 (306), which are not elements in sentiment dictionary 200. Starting sentiment 402 displays the sentiment of elements in column 410 prior to the analysis of messages 1 (302) and message 2 (306). Here, this is a first encounter and the starting sentiment in column 402 is zero. In other embodiments, the starting sentiment may be NULL or other indicator of a neutral, void, unusable or other indication that a particular member of column 410 has not had a sentiment value determined.

Column 404 illustrates an analysis of message 1 (302). Message 1 (302) had one element 202A within sentiment dictionary 200. Column 406 illustrates an analysis of message 2 (306), which has two elements, element 202B and 202C. Elements in column 410 occurring within message 1 (302) and, therefore, element 202A (“terrible”) are mapped to a similar sentiment score as element 202A, in this case “−1.” Similarly, elements in column 410 occurring within message 2 (306) are mapped to similar sentiment scores as those elements that also occur within message 2 (306), in particular, elements 202B (“bad”) and 202C (“late”). In one embodiment, column 408 illustrates an average sentiment score of the elements in column 410, which may then be used to extend sentiment dictionary 200.

Element 412 (“battery”) in column 410 is common to both message 1 (302) and message 2 (306). The ending sentiment 414 for element 412 is therefore determined by the occurrence of the element 412 within both message 1 (302) and message 2 (306). The specific algorithm selected to determine a sentiment is a matter of design choice and may be tuned over time. In one embodiment, elements that occur below a certain frequency may be kept in a neutral sentiment, regardless of any other determination, as the infrequent occurrence of an element may erroneously bias the few messages that also include the element. Other algorithms for determining a sentiment may be an average, as illustrated in FIG. 4, mean, mode, range, weighed value, or other means.

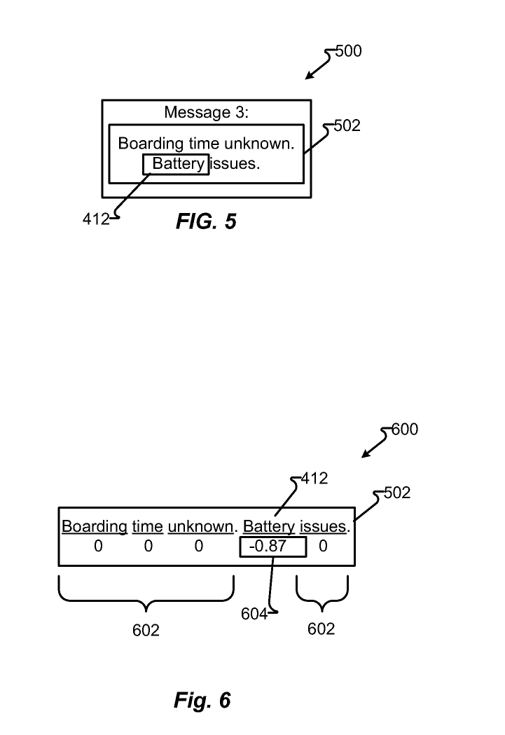

FIG. 5 is message 3 (500) operable to have a sentiment determined by an extended sentiment dictionary. In one embodiment, message 3 (500) is analyzed with the benefit of sentiment dictionary 200, including element 412 from message 1 (302) and message 2 (306).

FIG. 6 is diagram 600 illustrating one scoring algorithm operable to determine the sentiment of message 500. Message 3 (500) text 502 includes no elements within the initial sentiment dictionary 200. However, sentiment dictionary 200 is extended by analysis of message 1 (302) and message 2 (306), (see FIGS. 3-4). Element 412 (“battery”) is found in message 3 (500) and has sentiment 604 (e.g., ‘−0.87’). As a result, message 3 (500) may be determined to have a negative sentiment as message 3 (500) text 502 includes neutral elements 602 and element 412 which has negative sentiment 604.

While embodiment illustrated with respect to FIG. 6 is a simple summation of elements of text 502 to determine the sentiment of message 3 (500), other methodologies may be employed as a matter of design choice. For example, had element 412 had sentiment 604 which was below a threshold, it may be determined that message 3 (500) is substantially neutral and therefore, should be determined to be scored as having a neutral sentiment. In another embodiment, had text 502 been longer and the only element with a non-neutral sentiment remained element 412, such a message may also be determined to be neutral based on element 412 being diluted by a lengthy text. In embodiments wherein the text comprises elements with both positive and negative sentiments, only the positive or negative elements may be selected for scoring a message. In still another embodiment, messages with elements that have a derived sentiment (e.g., they form elements extending sentiment dictionary 200) may be weighted differently than those which are considered “gold standard” entries (e.g., elements of non-extended sentiment dictionary 200). And in still another embodiment, the age and/or frequency of occurrences of an element may weight the associated sentiment of the element when determining the sentiment for a containing message.

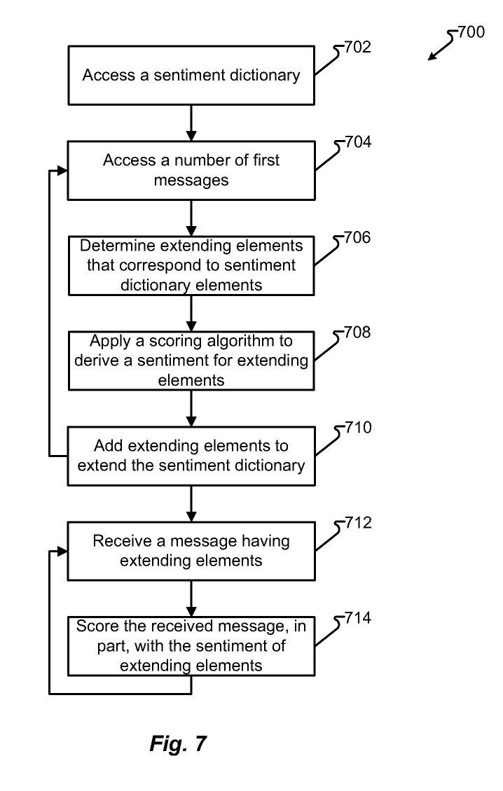

FIG. 7 is flowchart 700 illustrating one method of in accordance with embodiments of the present disclosure. Step 702 accesses a sentiment dictionary, such as by processor 102, and stored as sentiment dictionary 104. Step 704 accesses a number of first messages, such as those stored in messages 106. Step 706 then determines a number of extending elements within the number of messages. An extending element being an element in at least one message whereby a sentiment may be derived and then added, thereby extended, the sentiment dictionary.

Step 708 applies a scoring algorithm to derive a sentiment to extending elements. As discussed more fully above, the specific algorithm may be a matter of design choice. Step 710 adds the extending elements and associated sentiment to the sentiment dictionary. Completion of step 710 provides for one iteration of extension to the sentiment dictionary. Processing may continue back to step 704 and/or continue with step 712.

In another embodiment, elements may be removed from sentiment dictionary 200. In a further embodiment, an element may used less frequently and/or be associated with other sentiments. For example, if element 412 (“battery”) ceased to be associated with a negative sentiment, such as when flights were no longer impacted by battery issues, element 412 may become neutral or substantially neutral. As a result, the term “battery” may be determined to have a neutral sentiment, or neutral within a range, and removed from sentiment dictionary 200.

In another embodiment, a method of downgrading a “learned” sentiment word would be to use a leaky integrator to devalue the sentiment over time based on frequency of occurrence. As the issue with batteries is resolved, the use of the term drops toward zero and the integrator would do the same to the value that was learned for the term.

Step 712 receives a message with extending elements 712. The message may also include elements within non-extended sentiment dictionary and scored with benefit thereof. Step 712 may be the accessing of a message and may be performed in real-time, batch, or a combination thereof. Step 714 then scores the message in accord with the extending elements. Processing may end or, as illustrated, continue back to step 712 to process another message.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of determining a sentiment, comprising:
accessing a sentiment dictionary comprising a number of elements each having an associated sentiment;
accessing a first number of messages, each message having a first element defined in the sentiment dictionary and a second element; and
setting a sentiment associated with the second element in accord with the sentiment of the first element.

2. The method of claim 1, further comprising, upon determining the second element is absent in the sentiment dictionary, creating an entry in the sentiment dictionary comprising the second element.

3. The method of claim 2, further comprising, upon determining the second element sentiment is absent in the sentiment dictionary, creating a sentiment of the second element in the sentiment dictionary.

4. The method of claim 1, wherein setting the sentiment of the second element, further comprises, updating the sentiment of the second element in the sentiment dictionary.

5. The method of claim 1, further comprising, saving the second element and associated second element sentiment in the sentiment dictionary.

6. The method of claim 1, further comprising:
accessing a second number of messages, each message having at least one second element;
determining the sentiment of ones of the second number of messages in accord with the sentiment of the at least one second elements.

7. The method of claim 6, further comprising:
determining the sentiment of ones of the second number of messages in accord with a sentiment of the at least one second elements and the sentiment of the at least one first elements.

8. The method of claim 1, further comprising:
determining, for a plurality of first elements associated with the second element, a first number of first elements have a substantially positive sentiment of a first weight and a second number of first elements have a substantially negative sentiment of a second weight and the first weight and second weight are substantially equivalent; and
setting the sentiment of the second element to a neutral sentiment.

9. The method of claim 1, further comprising:
determining the frequency of occurrence of the second element in the first number of messages occurs below a previously determined threshold; and
setting the sentiment of the second element to a neutral sentiment.

10. The method of claim 1, further comprising:
determining the frequency of occurrence of the second element in the first number of messages is trending downward; and
setting the sentiment of the second element to a weighted neutral sentiment.

11. A system, further comprising:
a data storage;
a processor;
a network connection, to facilitate communications between the processor and the data storage; and
wherein the data storage is operable to store a sentiment dictionary having a number of entries each having an element and a sentiment associated with the element;
wherein the data storage is further operable to store messages;
wherein the processor is operable to access the sentiment dictionary;
wherein the processor is further operable to access a first number of the messages, each of the first number of messages having a first element defined in the sentiment dictionary and a second element; and
wherein the processor is further operable to cause the sentiment associated with the second element to be set in the sentiment dictionary in accord with the sentiment of the first element.

12. The system of claim 11, wherein, the processor is further operable to (i) upon determining the second element is absent in the sentiment dictionary, causing an entry in the sentiment dictionary comprising the second element to be created, (ii) upon determining the second element sentiment is absent in the sentiment dictionary, causing the sentiment of the second element in the sentiment dictionary to be created, and (iii) upon determining the sentiment of the second element exists in the sentiment dictionary, causing the sentiment of the second element to be updated in the sentiment dictionary.

13. The system of clam 11, further comprising, the processor further being operable to cause the second element and the associated sentiment to be saved in the sentiment dictionary.

14. The system of claim 11, wherein the processor is further operable to:
access a second number of messages, each message having at least one second element;
determine the sentiment of ones of the second number of messages in accord with the sentiment of the at least one second elements.

15. The system of claim 14, wherein the processor is further operable to determine the sentiment of ones of the second number of messages in accord with a sentiment of the at least one second elements and the sentiment of the at least one first elements.

16. The method of claim 1, wherein the processor is further operable to:
determining, for a plurality of first elements associated with the second element, a first number of first elements have a substantially positive sentiment of a first weight and a second number of first elements have a substantially negative sentiment of a second weight and the first weight and second weight are substantially equivalent; and
causing the sentiment of the second element to be set in accord with a neutral sentiment.

17. A non-transitory medium stored thereon instructions that when executed by a machine cause the machine to perform:
accessing a sentiment dictionary comprising a number of elements each having an associated sentiment;
accessing a first number of messages, each message having a first element defined in the sentiment dictionary and a second element; and
setting a sentiment associated with the second element in accord with the sentiment of the first element.

18. The medium of claim 17, further comprising instructions for, saving the second element and associated second element sentiment in the sentiment dictionary.

19. The medium of claim 17, further comprising instructions for:
accessing a second number of messages, each message having at least one second element;
determining the sentiment of ones of the second number of messages in accord with the sentiment of the at least one second elements.

20. The medium of claim 19, further comprising instructions for:
determining the frequency of occurrence of the second element in the first number of messages is trending downward; and
setting the sentiment of the second element to a weighted neutral sentiment.
